(19) United States
(12) Patent Application Publication
(10) Pub. No.: US 2019/0302319 A1
(43) Pub. Date: Oct. 3, 2019

(54) MARKER AND MARKER SET

(71) Applicant: ENPLAS CORPORATION, Kawaguchi-shi, Saitama (JP)

(72) Inventor: Tomohiro SAITO, Saitama (JP)

(21) Appl. No.: 16/346,443

(22) PCT Filed: Oct. 19, 2017
(86) PCT No.: PCT/JP2017/037826

§ 371 Date: Apr. 30, 2019

(30) Foreign Application Priority Data
Nov. 22, 2016 (JP) 2016-227135

(51) Int. Cl. G02B 3/00; G01B 11/26

(52) U.S. Cl. CPC G02B 3/005; G06K 7/1417; G01B 11/26

(57) ABSTRACT

The present invention provides a marker that allows a viewing direction to be determined from a detected image. A marker (100) according to the present invention includes: a lens main body (110) including a plurality of lens units (121) and a plurality of non-lens units (122). The plurality of lens units (121) and the plurality of non-lens units (122) are arranged alternately in a planar direction. Each of the lens units (121) includes, on one surface side of the lens main body (110), a light-condensing convex-shaped lens portion (121a) provided along an arrangement direction in which the lens units (121) and the non-lens units (122) are arranged. Each of the non-lens units (122) includes, on the one surface side of the lens main body (110), a non-light-condensing non-lens portion (122a). The lens main body (110) includes, on the other surface (140) side of the lens main body (110), a plurality of detectable portions (141) that can be detected from the one surface side.

### TECHNICAL FIELD

The present invention relates to a marker and a marker set.

### BACKGROUND ART

In the fields of augmented reality (also referred to as “AR” hereinafter), robotics, etc., a so-called visual marker is used to recognize the position, the orientation, and the like of an object. As an example of such a marker, there has been reported a marker that includes a lenticular lens arranged on a black stripe pattern (Patent Literature 1).

The lenticular lens generally is a lens main body composed of cylindrical lenses arranged successively. Each of the cylindrical lenses has a structure obtained by dividing a cylinder in the axial direction and has a convex portion extending along the axial direction. In the lenticular lens, the cylindrical lenses are arranged in such a manner that the axial directions thereof are parallel with each other. In the above-described marker, the lenticular lens is arranged on the stripe pattern in such a manner that the axial directions of the cylindrical lenses are parallel with the directions in which the black lines of the stripe pattern extend and the pitch of the cylindrical lenses is different from the pitch of the stripe pattern. With such a configuration, when the marker is recognized visually with a camera or the like from the convex portion side of the lenticular lens, the pattern projected on the lenticular lens is detected as an image that moves or deforms depending on the viewing direction. Accordingly, the viewing direction can be recognized from the detected image, and therefore, the position, the orientation, and the like of the object can be recognized as described above.

### CITATION LIST

### Patent Literature

[Patent Literature 1] JP 2012-145559 A

### SUMMARY OF INVENTION

### Technical Problem

However, for example, when the visual angle is increased gradually relative to the normal line (0°) that passes through the apex of the convex portion of the lenticular lens, an image (B1) of the above-described pattern that has appeared from one end side of the marker when the visual angle is a certain angle (A1°) moves to the other end side as the visual angle is increased. Then, when the visual angle is increased further (angle (A2°), A2°>A1°), a new image (B2) of the pattern may appear from the one end side. In this case, the first image (B1) and the new image (B2) appear at the same position and then move. Accordingly, even if either of these images appears at a certain position, it may be not possible to determine at which visual angle (A1° or A2°) the image is obtained. The same applies to the case where the visual angle is decreased gradually.

With the foregoing in mind, it is an object of the present invention to provide a marker and a marker set that allow a viewing direction to be determined from a detected image.

### Solution to Problem

In order to achieve the above object, the present invention provides a marker including: a lens main body including a plurality of lens units and a plurality of non-lens units, wherein the plurality of lens units and the plurality of non-lens units are arranged alternately in a planar direction, each of the lens units includes, on one surface side of the lens main body, a light-condensing convex-shaped lens portion provided along an arrangement direction in which the lens units and the non-lens units are arranged, each of the non-lens units includes, on the one surface side of the lens main body, a non-light-condensing non-lens portion, the lens main body includes, on the other surface side of the lens main body, a plurality of detectable portions that can be detected from the one surface side, and a pitch of the plurality of lens units is different from a pitch of the plurality of detectable portions.

### Advantageous Effects of Invention

As described above, the marker of the present invention is configured such that the lens main body includes the plurality of lens units and the plurality of non-lens units that are arranged alternately. With this configuration, it is possible to determine the viewing direction from a detected image.

### BRIEF DESCRIPTION OF DRAWINGS

FIG. 1A is a top view showing an example of a marker according to a first embodiment, and

FIG. 1B is a cross-sectional view of the marker shown in FIG. 1A as viewed in the arrow direction of line I-I in FIG. 1A.

FIG. 2 is a cross-sectional view schematically illustrating the relationship between lens units and non-lens units in the marker of the first embodiment.

FIG. 3 is a cross-sectional view schematically illustrating, regarding a lens unit in the marker of the first embodiment, the relationship between the normal line and inclined lines.

FIG. 4 is a cross-sectional view showing a variation of the marker according to the first embodiment.

FIGS. 5A and 5B are schematic views illustrating an image that changes with change in visual angle. FIG. 5A relates to the marker of the first embodiment shown in FIGS. 1A and 1B, and FIG. 5B relates to a marker of a comparative example shown in FIG. 8.

FIGS. 6A and 6B are schematic views illustrating an image that changes with change in visual angle. FIG. 6A relates to the marker of the first embodiment shown in FIGS. 1A and 1B, and FIG. 6B relates to the marker of the comparative example shown in FIG. 8.

FIGS. 7A to 7D are top views showing examples of a marker set according to a second embodiment.

FIG. 8 is a cross-sectional view showing an example of a marker with successively-arranged lenses.

### DESCRIPTION OF EMBODIMENTS

The marker of the present invention may be configured such that, for example, on the one surface side of the lens main body, each of the non-lens portions has a planar or concave surface.

The marker of the present invention may be configured such that, for example, each of the lens units is a cylindrical lens.

The marker of the present invention may be configured such that, for example, a length (C) of the cylindrical lens portion in the arrangement direction and a length (NC) of the non-lens portion in the arrangement direction satisfy C≥NC.

The marker of the present invention may be configured such that, for example, each detectable portion is arranged so as to extend, with respect to a lens unit closest thereto and non-lens units adjacent to this lens unit on both sides of the lens unit, from a region on a side closer to the lens unit in one of the non-lens units to a region on a side closer to the lens unit in the other one of the non-lens units via the lens unit. In this case, for example, the region closer to the lens unit in each of the non-lens units is a region whose length is ¼ of the length of the non-lens unit in the arrangement direction.

The marker of the present invention may be configured such that, for example, each of the detectable portions is arranged in a region between a straight line that is inclined at −40° and a straight line that is inclined at +40° with respect to the arrangement direction, with a normal line to an apex of the convex-shaped lens portion of the lens unit as a reference (0°).

The marker of the present invention may be configured such that, for example, in the lens main body, a pattern is formed by the plurality of detectable portions.

The marker of the present invention may be configured such that, for example, in the lens main body, the detectable portions are lines that extend in a direction perpendicular to the arrangement direction, and the pattern is a stripe pattern formed by the lines.

The marker of the present invention may be configured such that, for example, the lens main body includes, on the other surface side of the lens main body, a plurality of recesses or protrusions, and when the lens main body includes the recesses, the detectable portions are provided inside the recesses, and when the lens main body includes the protrusions, the detectable portions are provided on leading end portions of the protrusions. The marker of the present invention may have colored films as the detectable portions, for example.

The marker of the present invention may be configured such that, for example, the other surface side of the lens main body is a flat surface, and the respective detectable portions are fixed on the flat surface.

The marker of the present invention may be configured such that, for example, the lens main body is a light-transmitting member.

The marker of the present invention may be configured such that, for example, the lens main body is an integrally molded article of the plurality of lens units and the plurality of non-lens units.

The marker of the present invention may be configured such that, for example, the lens main body is an injection molded article.

Next, embodiments of the present invention will be described with reference to the drawings. It is to be noted, however, that the present invention is by no means limited or restricted by the following embodiments. In the respective drawings, the same components/portions are given the same reference numerals. In the drawings, the structure of each component/portion may be shown in a simplified form as appropriate for convenience of illustration, and the dimension ratio and the like of each component/portion are not limited to the conditions shown in the drawings.

### First Embodiment

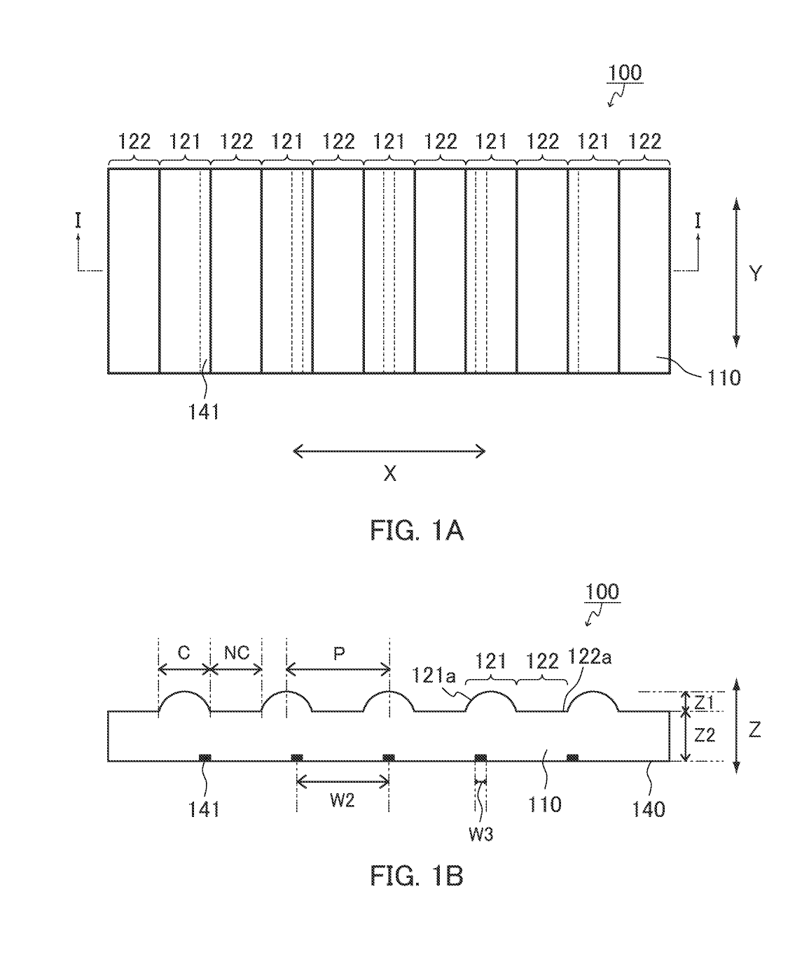

The first embodiment relates to an example of a marker of the present invention. FIGS. 1A and 1B show an example of the marker of the present embodiment. FIG. 1A is a top view of a marker 100, and FIG. 1B is a cross-sectional view of the marker 100 as viewed in the arrow direction of line I-I in FIG. 1A. In FIG. 1B, hatching representing a cross section is omitted for clarity of illustration. Hereinafter, the same applies to other cross-sectional views.

As shown in FIGS. 1A and 1B, the marker 100 includes a lens main body 110 that includes a plurality of lens units 121 and a plurality of non-lens units 122, and the plurality of lens units 121 and the plurality of non-lens units 122 are arranged alternately in the planar direction. The direction in which the plurality of lens units 121 and the plurality of non-lens units 122 are arranged is referred to as an arrangement direction or a width direction, and is indicated by arrow X in FIGS. 1A and 1B. For the sake of convenience of explanation, in FIGS. 1A and 1B, the left side of the arrangement direction X is referred to as upstream and the right side of the arrangement direction X is referred to as downstream. Regarding the marker 100, a direction perpendicular to the arrangement direction X in the planar direction is referred to as a length direction and is indicated by arrow Y in FIG. 1A and a direction perpendicular to the arrangement direction (width direction) X and to the length direction Y is referred to as a thickness direction and is indicated by arrow Z in FIG. 1B.

As shown in FIG. 1B, in the cross-sectional view taken along the arrangement direction X, the lens unit 121 is a region indicated by arrow C and the non-lens unit 122 is a region indicated by arrow NC. The respective lens units 121 include, on one surface side of the lens main body 110, i.e., on the side of a surface located upward (upper surface) in FIG. 1B, light-condensing convex-shaped lens portions 121a that are provided along the arrangement direction X. The respective non-lens units 122 includes, on one surface side of the lens main body 110, i.e., on the side of a surface located upward (upper surface) in FIG. 1B, non-light-condensing non-lens portions 122a that are provided along the arrangement direction X. The lens main body 110 includes a plurality of detectable portions 141 on the other surface side of the lens main body 110, i.e., on the side of a surface 140 located downward (lower surface or rear surface) in FIG. 1B.

The marker of the present invention need only be configured such that, as described above, the lens main body includes the lens units and the non-lens units that are arranged alternately along the arrangement direction in which the lens units and the non-lens units are arranged successively, and other configurations are not particularly limited. In the present invention, the lens portion of the lens unit means a portion having a function of condensing light, and the non-lens portion of the non-lens unit means a portion not having a function of condensing light. Since the marker of the present invention includes the lens units and the non-lens units that are provided alternately as descried above, it also can be referred to as a marker with non-successively arranged lenses. In contrast, conventional markers in which lens units are arranged successively also can be referred to as markers with successively arranged lenses.

In each of the lens units 121, a surface of the lens portion 121a is a convex curved surface. The shape of the surface of the lens portion 121a means, for example, a surface shape in a cross section taken in the thickness direction Z, and more specifically, a surface shape in a cross section taken in the thickness direction Z along the arrangement direction (width direction) X. The lens portion 121a need only be capable of condensing light, and for example, the curvature of the curved surface is not particularly limited. In the lens portion 121a, the radius of curvature (R) of the curved surface in the cross section taken in the thickness direction increases from the apex of the lens portion 121a toward the non-lens unit 122 adjacent thereto on both sides, for example. The radius of curvature (R) may increase either continuously or intermittently, for example. The radius of curvature at the apex of the lens portion 121a is 0.25 mm, for example. The lens unit 121 is a cylindrical lens, for example.

On one surface (upper surface in FIG. 1B) side of the lens main body 110, the non-lens portion 122a has a planar surface, for example. The shape of the non-lens portion 122a is not limited to this example. For example, the surface of the non-lens portion 122a may have a concave surface in the cross section taken in the thickness direction.

The size ratio between the lens unit 121 and the non-lens unit 122 in the lens main body 110 is not particularly limited. In the width direction X, the width (C) of the lens unit 121 and the width (NC) of the non-lens unit 122 satisfy C≥NC, for example. The ratio (C:NC) between the width (C) of the lens unit 121 and the width (NC) of the non-lens unit 122 is, for example, 3:1 to 1:1, 2:1 to 1:1, or 1:1. The length of the lens unit 121 in the width direction X, i.e., the width C in FIG. 1B is, for example, 370 μm. The length of the non-lens unit 122 in the width direction X, i.e., the width NC in FIG. 1B is, for example, 185 μm or 370 μm.

The lens main body 110 may be formed by connecting a plurality of separately prepared lens units 121 and a plurality of separately prepared non-lens units 122, or may be an integrally molded article of the plurality of lens units 121 and the plurality of non-lens units 122, for example. The lens main body 110 is, for example, an injection molded article. In particular, when the lens main body 110 is the above-described integrally molded article, it is preferable that the lens main body 110 is an injection molded article.

The lens main body 110 is, for example, a light-transmitting member. The light-transmitting member is not particularly limited, and may be formed of a resin, glass, or the like, for example. The resin may be, for example, an acrylic resin such as a polycarbonate and polymethyl methacrylate (PMMA), a cycloolefin polymer (COP), a cycloolefin copolymer (COC), or the like.

Although FIGS. 1A and 1B shows an example where the number of the lens units 121 is five and the number of the non-lens units 122 is six, this example is merely illustrative and the present invention is not limited to this illustrative example. The number of the lens units 121 and the number of the non-lens units 122 may be the same or different from each other. Components provided at the ends of the lens main body 110 in the width direction both may be the non-lens units 122 or lens units 121, or the non-lens unit 122 may be provided at one of the ends and the lens unit 121 may be provided at the other end, for example. The number of the lens units 121 and the number of the non-lens units 122 in the lens main body 110 are not particularly limited, and may each be 47, for example.

The size of the lens main body 110 is not particularly limited, and can be determined as appropriate depending on the number of the lens units 121, the number of the non-lens units 122, the intended use of the marker 100, and the like, for example. The size of the lens main body 110 may be such that the length in the width direction X (i.e., the width) is 10 mm, for example, the length in the length direction Y is 4 mm or 15 mm, for example, and the length in the thickness direction Z (i.e., the thickness) is 0.7 mm, for example.

In the present invention, the “pitch of the plurality of lens units” means the pitch P between lens units that are adjacent to each other via the non-lens unit. The pitch between the lens units that are adjacent to each other via the non-lens unit may be uniform or nonuniform, and preferably is uniform. In the present invention, the “pitch of the plurality of lens units” in the arrangement direction is different from the “pitch of the plurality of detectable portions” in the arrangement direction.

As shown in FIGS. 1A and 1B, the pitch P between lens units 121 that are adjacent to each other via a non-lens unit 122 is equal to the sum of the width (C) of the lens unit 121 and the width (NC) of the non-lens unit 122 (C+NC), for example. The “pitch P” is, for example, the distance between apexes (the distance between ridge lines of the lens units 121) of the lens portion 121a of the adjacent lens units 121. The apex of the lens portion 121a is, for example, the highest position in the thickness direction, and the ridge line of the lens unit 121 is, for example, a straight line that is located at the highest position in the cross section taken in the thickness direction and extends in the length direction Y.

The pitch between the non-lens units 122 that are adjacent to each other via the lens unit 121 is equal to, for example, the pitch P between the lens units 121, i.e., the sum of the width (C) of the lens unit 122 and the width (NC) of the non-lens unit 121 (C+NC), for example. The “pitch between non-lens units” is, for example, the distance between midpoints of the non-lens portions 122a of the adjacent non-lens units 122 in the width direction.

As described above, the lens main body 110 includes a plurality of detectable portions 141 on the other surface side of the lens main body 110, i.e., on the side of a surface located downward (lower surface) in FIG. 1B. In FIG. 1B, the detectable portions 141 are lines that extend along the length direction Y of the lens main body 110, and a stripe pattern is formed by the plurality of lines. The plurality of detectable portions 141 are projected on the upper surface side of the lens main body 110 as optically detectable images and can be detected optically, for example.

The width W3 of the detectable portion 141 in the width direction X is not particularly limited. The width of the detectable portion 141 can be determined as appropriate depending on the pitch P between the lens units 121 adjacent to each other via the non-lens unit 122, for example. By setting the width W3 of the detectable portion 141 so as to be relatively larger than the pitch P between the lens units 121, detected images can have relatively higher contrast, for example. On the other hand, by setting the width W3 of the detectable portion 141 so as to be relatively smaller than the pitch P between the lens units 121, the detectable portions 141 can be detected with further improved sensitivity, for example.

In the present invention, the “pitch of the plurality of detectable portions” means the pitch W2 between adjacent detectable portions. In the plurality of detectable portions, the pitch between each adjacent pair of detectable portions may be uniform or nonuniform, and preferably is uniform. In the present invention, the “pitch of the plurality of detectable portions” in the arrangement direction is different from the “pitch of the plurality of lens units” in the arrangement direction.

In the present invention, the “pitch between adjacent detectable portions” is, for example, the distance W2 between the centers of the adjacent detectable portions 141 in the width direction X. The center of the detectable portion 141 is, for example, a midpoint in the width direction X and also a midpoint in the length direction Y.

As described above, the distance W2 between the adjacent detectable portions 141 is different from the pitch P between the lens units 121. The distance W2 between the adjacent detectable portions 141 may be shorter than the pitch P between the lens units 121 as shown in FIG. 1B, or may be longer than the pitch P between the lens units 121, for example. The absolute value of the difference between the distance W2 of the adjacent detectable portions 141 and the pitch P of the lens units 121 is 10 μm, for example.

In FIGS. 1A and 1B, each detectable portion 141 is arranged in the closest lens unit 121 in the width direction X. However, this is merely illustrative, and the present invention is not limited thereto.

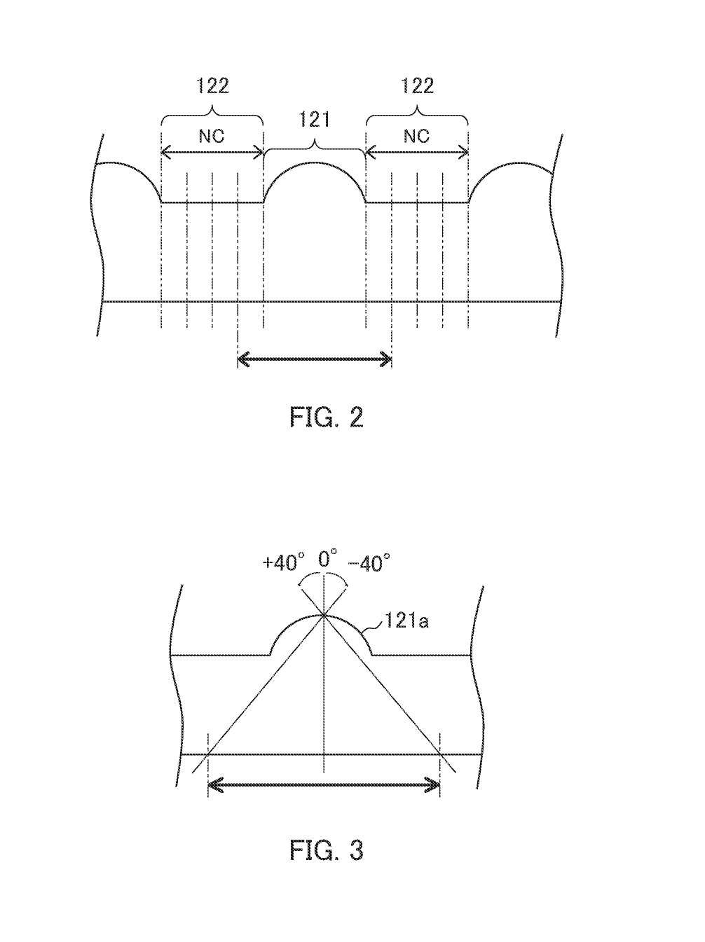

The detectable portion 141 is arranged so as to extend, with respect to a lens unit 121 closest thereto and non-lens units 122 adjacent to this lens unit 121 on both sides of the lens unit 121, from a region on a side closer to the lens unit 121 in one of the non-lens units 122 to a region on a side closer to the lens unit 121 in the other one of the non-lens units 122 via the lens unit 121, for example. The region closer to the lens unit 121 in each of the non-lens units 122 is, for example, a region whose length is equal to or less than ¼ of the length NC of the non-lens unit 122 in the arrangement direction X. This example is shown in FIG. 2. FIG. 2 is a partial cross-sectional view showing the lens unit 121 and the non-lens units 122 adjacent to this lens unit 121 on both sides of the lens unit 121. In FIG. 2, the arrangement region of the detectable portion 141 (not shown) is, for example, a region indicated by a thick arrow, the upstream end of the region is at a position corresponding to ¼ of the length NC in the arrangement direction X of the non-lens unit 122 on the upstream side, and the downstream end of the region is at a position corresponding to ¼ of the length NC in the arrangement direction X of the non-lens unit 122 on the downstream side. By arranging the detectable portion 141 in this manner, for example, the lens unit 121 can detect the detectable portion 141 closest to the lens portion 121a thereof more significantly than the other detectable portions.

The detectable portion 141 is arranged in a region between a straight line that is inclined at −40° and a straight line that is inclined at +40° with respect to the arrangement direction X, with the normal line that passes through the apex of the lens portion 121a as a reference (0°), for example. The angles of the inclined straight lines are from −40° to +40° or from −30° to +30°, for example. This example is shown in FIG. 3. FIG. 3 is a partial cross-sectional view showing the lens unit 121 and the non-lens units 122 adjacent thereto on both sides of the lens unit 121. In FIG. 3, the arrangement region of the detectable portion 141 (not shown) is, for example, a region indicated by a thick arrow, and the inclination angle is from −40° to +40°. By arranging the detectable portion 141 in this manner, for example, the lens unit 121 can detect the detectable portion 141 closest to the lens portion 121a of the lens unit 121 more significantly than other detectable portions.

The detectable portion 141 need only be optically detectable, and may be a colored film, for example. The color of the colored film is not particularly limited, and may be black, for example. The colored film may be, for example, a coating film, and can be formed of a coating material. The coating material is not particularly limited, and may be a liquid coating material or a powder coating material, for example. The coating film can be formed by coating and/or solidifying the coating material, for example. The coating method may be, for example, spray coating, screen printing, or the like. The solidifying method may be, for example, drying of the liquid coating material, curing of a curable component (e.g., a radical polymerizable compound or the like) in the coating material, baking of the powder coating material, or the like.

The detectable portions 141 may be arranged such that, for example, they are located on the inner side of the lens main body 110 relative to the exposed surface of the other surface (lower surface) 140 of the lens main body 110 or they protrude to the outside from the lens main body 110. In the former case, for example, the other surface 140 of the lens main body 110 may have recesses, and the colored films may be arranged in the recesses. In the latter case, for example, the other surface 140 of the lens main body 100 may be flat, and the colored films may be arranged (laminated) on the flat surface. Also, in the latter case, for example, the other surface 140 of the lens main body 100 may have protrusions, and the colored films may be arranged (laminated) on protruding leading end portions of the protrusions.

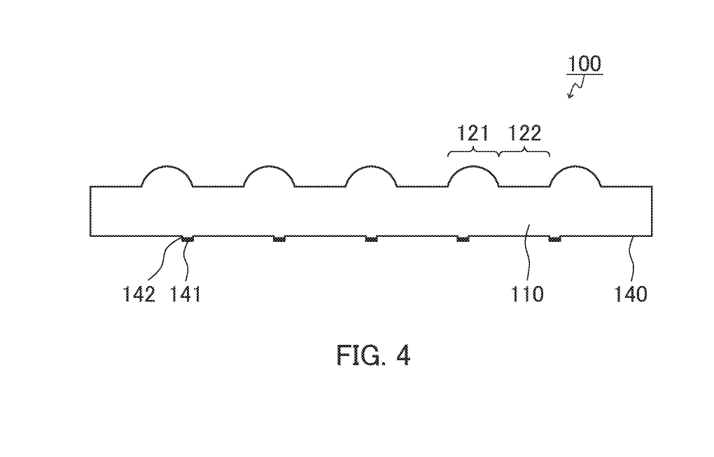

The cross-sectional view of FIG. 1B described above is directed to an example where the other surface (lower surface) 140 of the lens main body 100 has recesses and the colored films or the like are arranged in the recesses to form the detectable portions 141. The cross-sectional view of FIG. 4 shows an example where the other surface of the lens main body 100 has protrusions, and the colored films or the like are arranged on the protruding leading end portions of the protrusions to form the detectable portions. The marker shown in FIG. 4 is the same as the marker shown in FIG. 1B, except that the other surface 140 of the lens main body 100 has protrusions 142 and the detectable portions 141 are provided on the protrusions 142.

The detectable portions 141 need only be optically distinguishable, for example. The term “optically distinguishable” means that, for example, the detectable portions 141 can be detected with an optically significant difference as compared with regions other than the detectable portions 141. The term “optically significant difference” means that, for example, there is a significant difference with regard to optical characteristics. Examples of the optical characteristics include color properties such as lightness, saturation, and hue and the intensity of light such as luminance. The optically significant difference may be, for example, a difference that can be identified by visual observation or a difference that can be identified by an optical detection device such as a camera. When the detectable portions 141 emit fluorescence, for example, the optically significant difference may be a difference that can be identified by an operation such as light irradiation using a UV lamp.

The pattern formed by the detectable portions 141 is by no means limited. For example, when the pattern is the above-described stripe pattern, the density of the color forming the stripe pattern may be uniform, or the stripe pattern may contain color gradations, for example.

When the marker 100 is placed on, e.g., a white object, among light rays that have entered from the upper surface of the lens main body 110 of the marker 100, the light rays that have reached the detectable portions 141 are absorbed by the detectable portions 141 (e.g., black colored films), and the other light rays pass through the lens main body 110 and are reflected from the surface of the object. Accordingly, on the upper surface of the lens main body 110, images of the detectable portions 141 (e.g., black lines) are projected onto a white background.

The marker of the present invention need only be configured such that, as described above, the lens units and the non-lens units are arranged alternately in the state where the pitch of the lens units is different from the pitch of the detectable portions, and the size of each portion is not particularly limited. In the marker of the present invention, the size of each portion can be set as appropriate by, for example, setting the sizes of the lens units and the non-lens units.

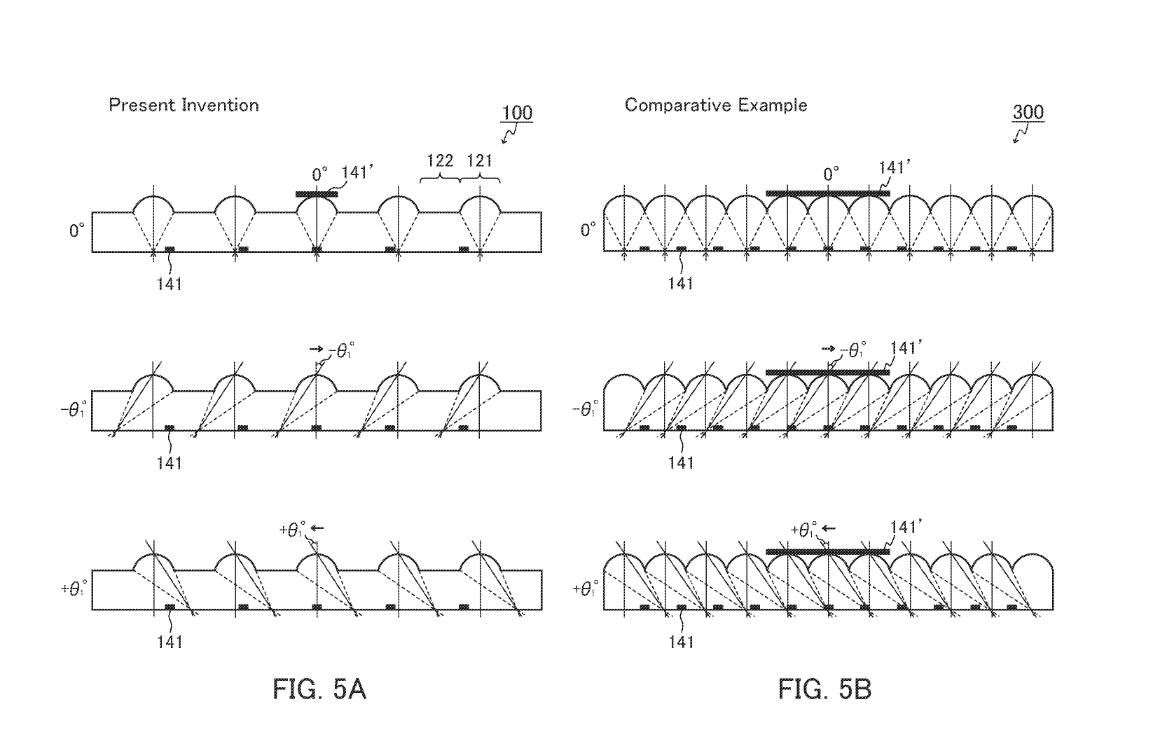

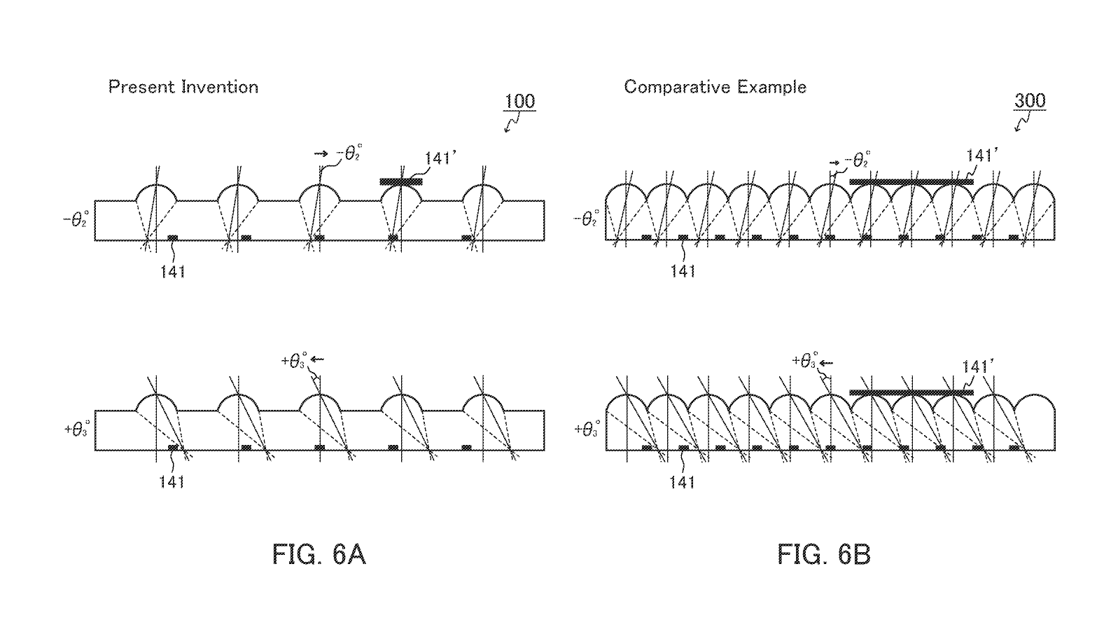

Next, images that change with inclination of light rays (viewing direction) at positive angles and images that change with inclination of light rays at negative angles in the case where the marker of the present invention shown in FIGS. 1A and 1B (marker with non-successively arranged lenses) is used will be described with reference to FIGS. 5A and 5B and FIGS. 6A and 6B. FIGS. 5A and 5B and FIGS. 6A and 6B show the marker with non-successively arranged lenses according to the present invention and a conventional marker with successively arranged lenses (comparative example) in order to provide an explanation based on the comparison between them.

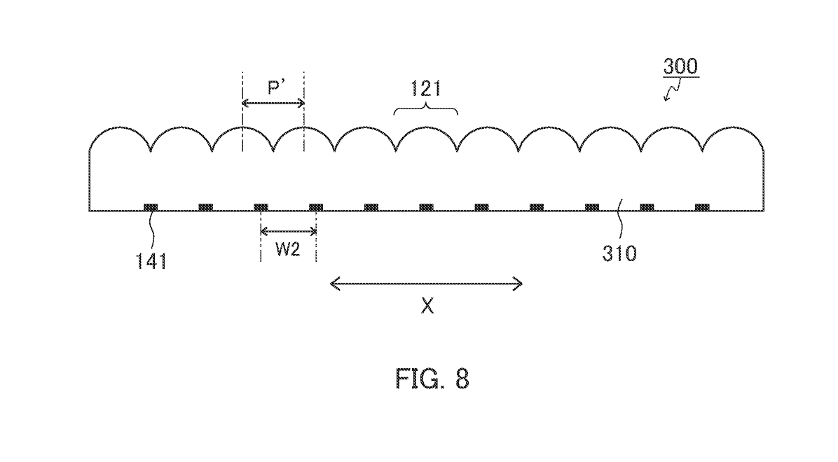

FIGS. 5A and 6A show the marker with non-successively arranged lenses according to the present inventive, which specifically is the marker 100 shown in FIGS. 1A and 1B. FIGS. 5B and 6B show the marker with successively arranged lenses according to the comparative example, which is a marker 300 shown in FIG. 8. FIG. 8 is a cross-sectional view of the marker 300 with successively arranged lenses. The marker 300 is the same as the marker 100 with non-successively arranged lenses, except that a lens main body 310 does not have non-lens units and that lens units 121 are arranged successively in a planar direction. In FIG. 8, the size of the lens unit 121 is the same as the lens unit 121 in FIGS. 1A and 1B, and the pitch P′ between the lens units 121 is the width C of the lens unit.

In each of FIGS. 5A and 5B and FIGS. 6A and 6B, solid lines that intersect the lens main body 110 and the lens main body 310 at right angles are the normal lines (0°). In FIGS. 5A and 5B and FIGS. 6A and 6B, for the sake of convenience of explanation, inclination toward the upstream side (left side) in the width direction X is explained as inclination at positive angles, and inclination toward the downstream side (right side) in the width direction X is explained as inclination at negative angles.

When light enters from the upper surface of the lens main body 110 of the marker 100 or the lens main body 310 of the marker 300, the light converges from the lens unit 121, and if the detectable portion 141 is present at the focal point, the image of the detectable portion 141 is projected onto the upper surface of the lens main body 110 or the lens main body 310.

First, an example will be described with reference to FIGS. 5A and 5B. FIGS. 5A and 5B are schematic views illustrating angles of light rays (viewing directions) with respect to the normal line (0°) and images detected at these angles. In FIGS. 5A and 5B, the first row shows an image obtained when inclination of light rays (viewing direction) is in the same state as the normal line, i.e., the inclination angle of the right rays is 0°, the second row shows an image obtained when the light rays are inclined at a negative inclination angle (−θ₁°) from the normal line, and the third row shows an image obtained when the light rays are inclined at a positive inclination angle (+θ₁°) from the normal line.

As shown in FIG. 5B, in the marker 300 of the comparative example, when the inclination angle of the light rays is 0°, three images are projected in a continuous state (image 141′) on the fifth, sixth, and seventh lens units from the upstream side. However, in both the cases where the light rays are inclined at a negative angle (−θ₁°) and where the light rays are inclined at a positive angle (+θ₁°), an image is projected at the same position as in the case where the inclination angle is 0°. This is presumably because, depending on the inclination angle of the light rays, the converged light from a certain lens unit 121 does not strike the detectable portion 141 corresponding to the lens unit 121 (the detectable portion 141 closest to the lens unit 121) but strikes the detectable portion 141 corresponding to the lens unit adjacent to this lens unit, whereby an image is projected. Therefore, according to the marker 300 of the comparative example, even if the image 141′ constituted by the continuous images is projected on the fifth, sixth, and seventh lens units, it is not possible to determine at which of the inclination angles 0°, −θ₁°, and +θ₁° the projected image is obtained.

In contrast, as shown in FIG. 5A, in the marker 100 of the present invention, the image 141′ is projected on the third lens unit from the upstream side when the inclination angle of the light rays is 0°, but no image is seen in either of the cases where the light rays are inclined at the negative angle (−θ₁°) and where the light rays are inclined at the positive angle (+θ₁°). Thus, according to the marker 100 of the present invention, when the image 141′ is projected on the third lens unit, it can be determined that the inclination angle is 0°.

Next, an example of the case where the inclination angles are different from those in the above will be described with reference to FIGS. 6A and 6B. FIGS. 6A and 6B are schematic views illustrating angles of light rays (viewing directions) with respect to the normal line (0°) and images detected at these angles. In FIGS. 6A and 6B, the first row shows an image obtained when the light rays are inclined at a negative angle (−θ₂°) from the normal line, and the third row shows an image obtained when the light rays are inclined at a positive angle (+θ₃°) from the normal line (|−θ₂°|<|+θ₃°|).

As shown in FIG. 6B, in the marker 300 of the comparative example, when the light rays are inclined at a negative angle (−θ₂°), three images are projected in a continuous state (image 141′) on the seventh, eighth, and ninth lens units from the upstream side. However, also in the case where the light rays are inclined at a positive angle (+θ₃°), an image is projected at the same position as in the case where the inclination angle is −θ₂°. Therefore, according to the marker 300 of the comparative example, even if the image 141′ constituted by the continuous images is projected on the seventh, eighth, and ninth lens unit, it is not possible to determine at which of the inclination angles −θ₂° and +θ₃° the projected image is obtained.

In contrast, as shown in FIG. 6A, in the marker 100 of the present invention, the image 141′ is projected on the fourth lens unit from the upstream side when the light rays are inclined at a negative angle (−θ₂°), but no image is seen when the light rays are inclined at a positive angle (+θ₃°). Thus, according to the marker 100 of the present invention, when the image 141′ is projected on the fourth lens unit, it can be determined that the inclination angle is −θ₂°.

As described above, the marker 300 of the comparative example has a problem in that, even if an image is projected at a certain position, it is not possible to determine at which inclination angle of light rays the image is obtained. In contrast, according to the marker 100 of the present invention, when an image is projected at a certain position, it is possible to determine at which inclination angle of light rays the image is obtained.

For the reason stated above, according to the marker of the present invention, reappearance as seen in conventional markers is prevented regardless of whether light rays are inclined at a positive angle or a negative angle, and it is possible to easily determine at which inclination angle a projected image is obtained.

### Second Embodiment

The second embodiment relates to an example of a marker set of the present invention including a marker of the present invention and a two-dimensional pattern code.

The marker set further includes, for example, a substrate, and the two-dimensional pattern code and the marker are arranged on the substrate. Also, the marker set may be configured such that, for example, it includes at least two markers, and at least one marker is the above-described marker with non-successively arranged lenses and at least one other marker is a marker with successively arranged lenses. In the marker set, the two-dimensional pattern code is an AR marker, for example.

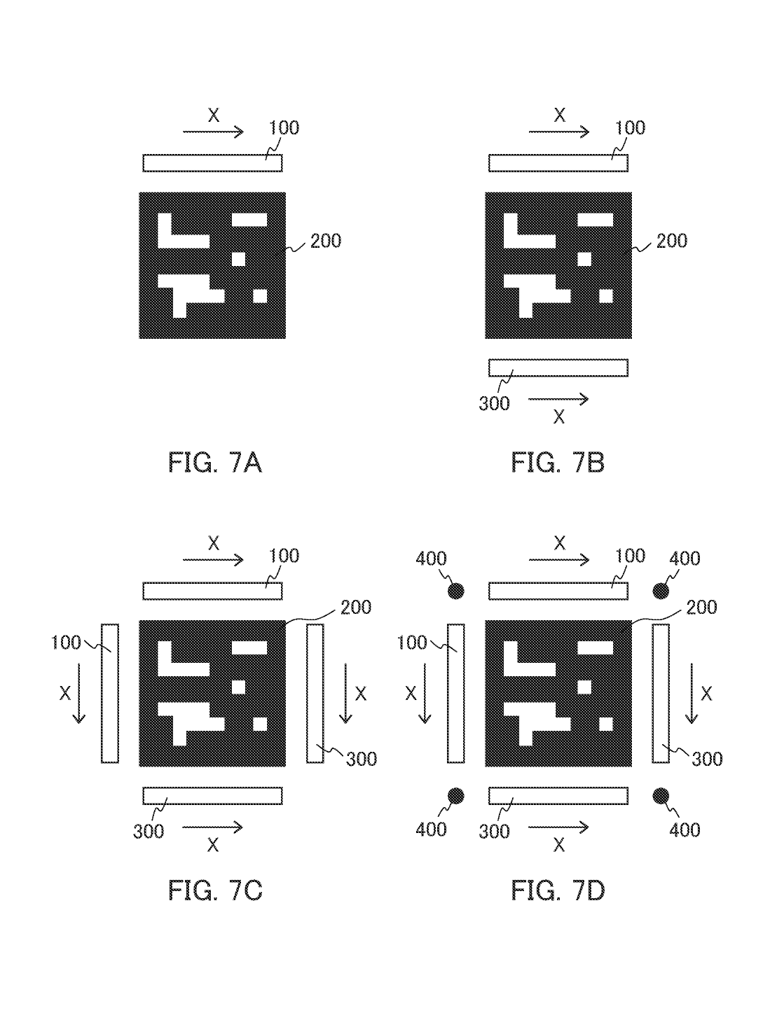

FIGS. 7A to 7D show specific examples of the marker set of the present embodiment.

FIG. 7A is a plan view of the marker set including the marker 100 of the first embodiment shown in FIGS. 1A and 1B and a two-dimensional pattern code. In FIG. 7A, arrow X indicates the same width direction X as in FIGS. 1A and 1B, and the arrowhead indicates a direction from the upstream side to the downstream side.

The two-dimensional pattern code is not particularly limited, and may be, for example, an AR marker, a QR marker, or the like. Examples of the AR marker include ARToolKit, ARTag, CyberCode, and ARToolKit Plus.

According to the marker set shown in FIG. 7A, the direction and angle of inclination of light rays (viewing direction) can be determined by detecting the marker 100 together with the AR marker.

FIG. 7B is a plan view of a marker set configured such that the marker set shown in FIG. 7A further includes a marker 300 with successively arranged lenses for a marker 100 with non-successively arranged lenses. In FIG. 7B, the marker 300 is the marker 300 shown in FIG. 8. The marker 100 with non-successively arranged lenses and the marker 300 with successively arranged lenses are arranged such that their width directions X extending from the upstream side to the downstream side are parallel with each other. Also, the marker 300 may be configured such that, for example, similarly to the marker 100 with non-successively arranged lenses shown in FIG. 4, a lower surface thereof has protrusions, and colored films or the like are arranged on protruding leading end portions of the protrusions to form the detectable portions 141.

According to the marker set of FIG. 7B, for example, when an image is detected on a third lens unit 121 from the upstream side in each of the marker 100 and the marker 300, it can be determined that the inclination angle is 0°, for example.

In FIG. 7B, the marker 100 and the marker 300 are arranged with the two-dimensional pattern code 200 interposed therebetween. It is to be noted, however, that the present invention is not limited thereto. For example, both the marker 100 and the marker 300 may be arranged in parallel with each other on either side of the two-dimensional pattern code 200.

FIG. 7C is a plan view of a marker set configured such that the marker set shown in FIG. 7B further includes another pair of a marker 100 with non-successively arranged lenses and a marker 300 with successively arranged lenses for the marker 100.

According to the marker set shown in FIG. 7C, for example, it is possible to determine, with respect to the plane of the paper of FIG. 7C, not only inclination in the vertical direction but also inclination in the horizontal direction.

FIG. 7D is a plan view of a marker set configured such that the marker set shown in FIG. 7C further includes indications (marks) 400 for specifying detection positions at four corners.

According to the marker set shown in FIG. 7D, a region to be detected can be specified easily with reference to the marks 400, for example. When the detection method is a method using an optical device such as a camera, by detecting the marks 400, for example, a region bounded by the marks 400 at the four corners can be specified as a region to be detected.

This application claims priority from Japanese Patent Application No. 2016-227135 filed on Nov. 22, 2016. The entire disclosure of this Japanese patent application is incorporated herein by reference.

### INDUSTRIAL APPLICABILITY

As described above, the marker of the present invention is configured such that the lens main body includes the plurality of lens units and the plurality of non-lens units that are arranged alternately. With this configuration, it is possible to determine the viewing direction from a detected image. The use of the marker of the present invention is not particularly limited. For example, the marker of the present invention can be used widely in the fields of AR and robotics for the purpose of recognizing the position, the orientation, and the like of an object.

### REFERENCE SIGNS LIST

100: marker
110, 310: lens main body
121: lens unit
121a: lens portion
122: non-lens unit
122a: non-lens portion
141: detectable portion
141′: image
142: protrusion
200: two-dimensional pattern code
300: marker with successively arranged lenses

1. A marker comprising:
a lens main body comprising a plurality of lens units and a plurality of non-lens units, wherein
the plurality of lens units and the plurality of non-lens units are arranged alternately in a planar direction,
each of the lens units comprises, on one surface side of the lens main body, a light-condensing convex-shaped lens portion provided along an arrangement direction in which the lens units and the non-lens units are arranged,
each of the non-lens units comprises, on the one surface side of the lens main body, a non-light-condensing non-lens portion,
the lens main body comprises, on the other surface side of the lens main body, a plurality of detectable portions that can be detected from the one surface side, and
a pitch of the plurality of lens units is different from a pitch of the plurality of detectable portions.

2. The marker according to claim 1, wherein
on the one surface side of the lens main body, each of the non-lens portions has a planar or concave surface.

3. The marker according to claim 1, wherein
each of the lens units is a cylindrical lens.

4. The marker according to claim 1, wherein
a length (C) of the lens unit in the arrangement direction and a length (NC) of the non-lens unit in the arrangement direction satisfy C≥NC.

5. The marker according to claim 1, wherein
each of the detectable portions is arranged in a region between a straight line that is inclined at −40° and a straight line that is inclined at +40° with respect to the arrangement direction, with a normal line that passes through an apex of the convex-shaped lens portion of the lens unit as a reference (0°).

6. The marker according to claim 1, wherein
in the lens main body, the detectable portions are lines that extend in a direction perpendicular to the arrangement direction, and a pattern formed by the plurality of detectable portions is a stripe pattern formed by the lines.

7. The marker according to claim 1, wherein
the lens main body has a plurality of recesses on the other surface side of the lens main body, and
the detectable portions are provided inside the respective recesses.

8. The marker according to claim 1, wherein
the lens main body is a light-transmitting member.

9. The marker according to claim 1, wherein
the lens main body is an injection molded article.
